(19) United States
(12) Patent Application Publication
(10) Pub. No.: US 2002/0074796 A1
(43) Pub. Date: Jun. 20, 2002

(54) Tube jointing structure

(76) Inventor: Yung-Yi Wang, Taichung Hsien (TW)

Correspondence Address: ROSENBERG, KLEIN & LEE, SUITE 101, 3458 ELLICOTT CENTER DRIVE, ELLICOTT CITY, MD, 21043, US

(21) Appl. No.: 09/737,574

(22) Filed: Dec. 18, 2000

(51) Int. Cl. F16L 13/02

(52) U.S. Cl. 285/288.1

(57) ABSTRACT

A tube jointing structure comprises a first tube, a second tube at an angle with the first tube, and a reinforcing plate for connecting the first tube with the second tube. A portion of the reinforcing plate is bonded to the first tube and the remaining portion of the reinforcing plate is soldered to the first tube and the second tube.

### BACKGROUND OF THE INVENTION

1. Field of the Invention

The present invention relates to a tube jointing structure with improved strength to prevent leakage in the soldering area of a reinforcing plate that is used to connect a tube with another tube.

2. Description of the Related Art

FIG. 1 of the drawings illustrates a conventional tube jointing structure, wherein a reinforcing plate 30 is used to connect a tube (e.g., a down tube 20 of a bicycle) to another tube (e.g., a head tube 10 of a bicycle). The reinforcing plate 30 is soldered to the down tube 20 and the head tube 10 along an outer periphery thereof, thereby forming a soldering area 40. However, strengths of the tubes 10 and 20 are adversely affected by the soldering heat. In addition, the protrusions resulting from soldering cause concentration of stress. Penetration of the soldering material also weakens the tubes 10 and 20. The anti-fatigue property of the tube jointing structure is also poor. As illustrated in FIG. 2, it was found that a crack is generated in the soldering area 40 of the soldered structure after impact tests, particularly in a left portion shown in FIG. 2. The crack grows and the soldered structure breaks accordingly. Solutions for reinforcing the tube jointing structure include polishing and impacting the soldering area 40 with steel balls, yet the procedure is troublesome and the result is not satisfactory to the conventional products.

### SUMMARY OF THE INVENTION

It is the primary object of the present invention to provide a tube jointing structure comprising a first tube, a second tube at an angle with the first tube, and a reinforcing plate for connecting the first tube with the second tube. A portion of the reinforcing plate is bonded to the first tube and the remaining portion of the reinforcing plate is soldered to the first tube and the second tube.

The reinforcing plate is bonded to the first tube at an area distal to the second tube.

A jointing area between the reinforcing plate and the first tube as well as the second tube may be polished or impacted by steel balls to improve its strength.

Other objects, advantages, and novel features of the invention will become more apparent from the following detailed description when taken in conjunction with the accompanying drawings.

### BRIEF DESCRIPTION OF THE DRAWINGS

FIG. 1 is a partial perspective view of a conventional tube jointing structure.

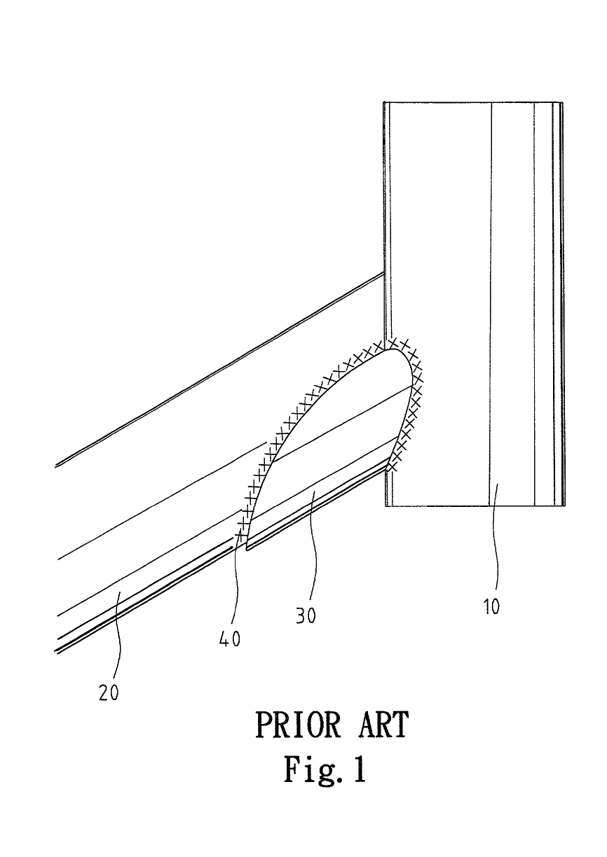

FIG. 2 is a perspective view similar to FIG. 1, illustrating cracking of the tube jointing structure

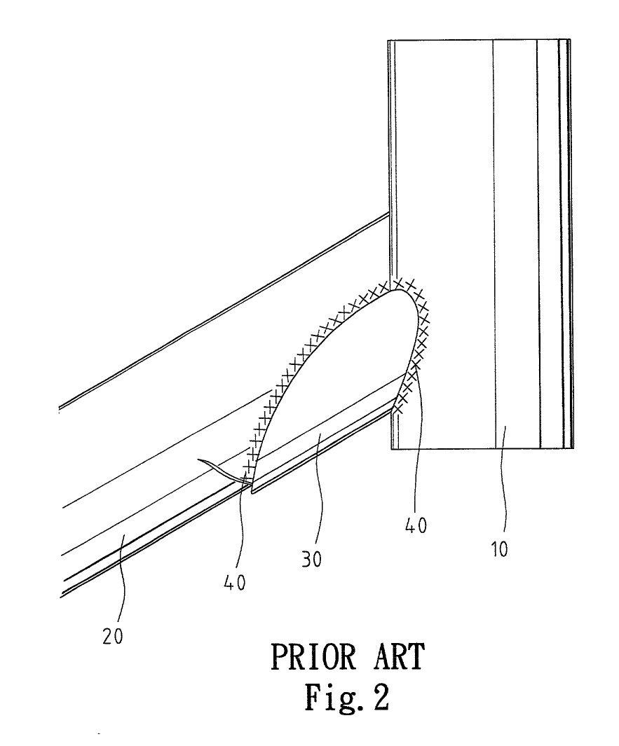

FIG. 3 is a partial perspective view of a tube jointing structure in accordance with the present invention.

### DETAILED DESCRIPTION OF THE PREFERRED EMBODIMENT

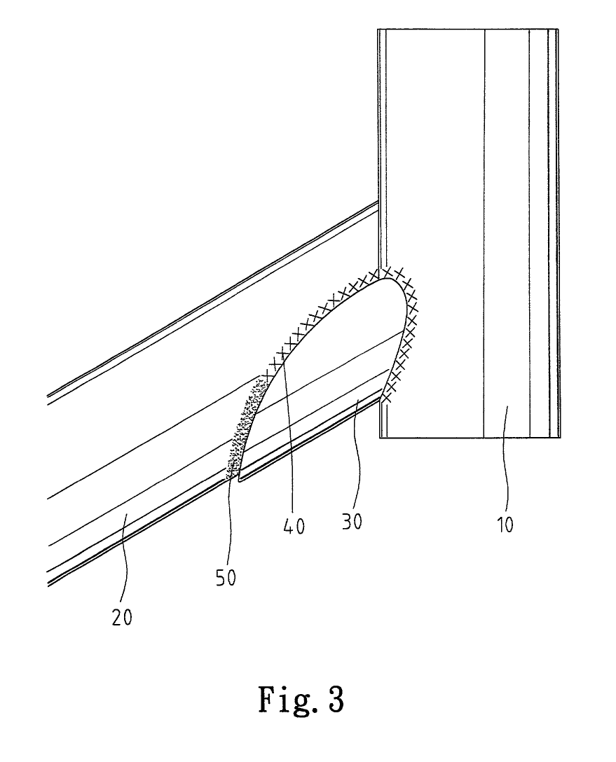

Referring to FIG. 3, a tube jointing structure in accordance with the present invention generally includes a first tube 20 (e.g., a down tube of a bicycle), a second tube 10 (e.g., a head tube of a bicycle), and a reinforcing plate 30 for connecting the first tube 20 and the second tube 10 together. The first tube 20 is at an angle other than zero degree with the second tube 10.

A portion of the reinforcing plate 30 is bonded to, e.g., the first tube 20 (see the bonding portion 50 in FIG. 3), and the remaining portion of the reinforcing plate 30 is soldered to the first tube 20 and the second tube 10 (see the soldering area). It is appreciated that the bonding portion 50 is distal to the second tube 10. By means of such arrangement, it is found that crack does not occur in the jointing area (including 50 and 40) after impact tests. Namely, no crack will be generated as long as the bonding area is still in firm bonding engagement. The strength and anti-fatigue property of the resultant tube jointing structure are better than those of the conventional products. The polishing or ball impacting procedures are not necessary, yet the strength and the anti-fatigue property will, of course, be improved by doing so.

Although the invention has been explained in relation to its preferred embodiment, it is to be understood that many other possible modifications and variations can be made without departing from the scope of the invention as hereinafter claimed.

What is claimed is:

1. A tube jointing structure comprising a first tube, a second tube at an angle with the first tube, and a reinforcing plate for connecting the first tube with the second tube, a portion of the reinforcing plate being bonded to the first tube and the remaining portion of the reinforcing plate being soldered to the first tube and the second tube.

2. The tube jointing structure as claimed in claim 1, wherein the reinforcing plate is bonded to the first tube at an area distal to the second tube.

3. The tube jointing structure as claimed in claim 1, wherein a jointing area between the reinforcing plate and the first tube as well as the second tube is polished.

4. The tube jointing structure as claimed in claim 1, wherein a jointing area between the reinforcing plate and the first tube and the second tube as well as impacted by steel balls.

5. The tube jointing structure as claimed in claim 1, wherein a second tube at an angle other than zero degree with the first tube.
